(19) United States
(12) Patent Application Publication
(10) Pub. No.: US 2018/0089948 A1
(43) Pub. Date: Mar. 29, 2018

(54) TABLE BONUSING SYSTEM AND METHOD

(71) Applicant: Eric B. Olsen, Las Vegas, NV (US)

(72) Inventor: Eric B. Olsen, Las Vegas, NV (US)

(21) Appl. No.: 15/276,360

(22) Filed: Sep. 26, 2016

(51) Int. Cl. G07F 17/32

(52) U.S. Cl. CPC G07F 17/3262; G07F 17/3211; G07F 17/3241; G07F 17/3258; G07F 17/3293; G07F 17/322

(57) ABSTRACT

A table bonusing system presents a bonus game with a jackpot and one or more ancillary awards to players of a base game at a gaming table. The table bonusing system comprises a controller in communication with one or more gaming tables. Qualifying wagers placed during the base game increment the jackpot and cause a card to be drawn from the bonus game's deck of cards. When the drawn card is of a randomly selected suit, the card is included in a set of placed cards. The jackpot is awarded when the set of placed cards forms a winning outcome. The controller presents its bonus game to players via a display at the gaming tables.

### BACKGROUND OF THE INVENTION

### Field of the Invention

The invention relates to bonus games and in particular to systems and methods for a community bonus for table games.

### Related Art

Table games, such as blackjack and poker, are played with a dealer and one or more players. During game play, one or more wagers may be placed, cards are dealt, and players attempt to achieve a winning outcome. To provide additional excitement side bets are sometimes available to players of a base game. When a player wins their side bet they are awarded winnings in addition to any winnings from play of the base game.

From the discussion that follows, it will become apparent that the present invention addresses the deficiencies associated with the prior art while providing numerous additional advantages and benefits not contemplated or possible with prior art constructions.

### SUMMARY OF THE INVENTION

A table bonusing system is disclosed herein. The table bonusing system typically provides a jackpot and one or more ancillary awards to players of a base game at a gaming table without meaningfully delaying the base game. The jackpot provides enticement to players to place qualifying wagers via its award. In general, players must place cards of a particular suit to win the jackpot. Ancillary awards will typically be provided to entice players to place qualifying wagers when only a few placed cards exist.

A table bonusing system may be implemented in various embodiments. For instance, in one exemplary embodiment a table bonusing system comprises a deck of cards stored on a storage device, a controller and a plurality of gaming tables.

The controller randomly generates a selected card suit, randomly generates a plurality of card draw threshold values and stores a jackpot value and one or more winning outcomes. The plurality of gaming tables comprise a table surface bearing a plurality of player positions where one or more wagers are received, one or more displays and one or more client devices. The client devices receive wager information and transmit the wager information to the controller, receive bonus game information and display the bonus game information on the displays. The wager information is generated based on the amount of the wagers, and the bonus game information comprises a set of placed cards and the jackpot value.

When the wager information indicates a qualifying wager has been placed, the controller increments the jackpot value, draws a card from the deck of cards when the jackpot value crosses one of the plurality of card draw thresholds, inserts the card into the set of placed cards when the card is of the selected card suit and awards the jackpot when the set of placed cards is one of the winning outcomes. The winning outcomes may be poker hands.

It is contemplated that the controller may award a special card award when the wager information the qualifying wager has been placed and the card drawn from the deck of cards does not have a suit. In addition or alternatively, the controller may award a placed card award when the wager information the qualifying wager has been placed and the card drawn from the deck of cards is of the selected card suit.

The plurality of gaming tables may comprise one or more currency detectors at each player position that receive the wager information. In such case, the currency detectors are in communication with the client device. The plurality of gaming tables may also or alternatively comprise one or more HIDs that receive the wager information. The HIDs are in communication with the client device as well. In some embodiments, two cards may be drawn from the deck of cards when the set of placed cards contains three cards.

In another exemplary embodiment, a table bonusing system may comprise a plurality of gaming tables, a display at each of the plurality of gaming tables that presents a jackpot and a set of placed cards to players, a storage device storing a deck of cards and a controller. The plurality of gaming tables include a table surface for receiving a plurality of physical playing cards for play of a base game, and a communication device for transmitting wager information.

The controller provides a bonus game by randomly selecting a card suit, randomly generating a plurality of card draw thresholds and receiving the wager information. The controller also detects a qualifying wager based on the wager information, increments the jackpot when the qualifying wager is detected, and draws a card from the deck of cards when the jackpot crosses one of the plurality of card draw thresholds. When the card is of the selected card suit, the card is inserted into the set of placed cards, and the jackpot is awarded when the set of placed cards is a winning outcome.

Similar to above, a special card award may be paid when the qualifying wager is detected and the card drawn from the deck of cards has no suit. Alternatively or in addition a placed card award may be paid when the qualifying wager is detected and the card drawn from the deck of cards is of the selected card suit.

One or more currency detectors that receive the wager information may be at each of the gaming tables. Alternatively or in addition, one or more HIDs that receive the wager information may be at teach of the gaming tables. A plurality of cards may be drawn from the deck of cards when the jackpot crosses one of the plurality of card draw thresholds. A payout dispenser for awarding the jackpot may be at each of the gaming tables.

Various methods for providing jackpots, ancillary awards or both to players of a base game at a gaming table are also disclosed herein. For instance, an exemplary method for providing one or more bonuses at a plurality of gaming tables is disclosed, with such method comprising randomly selecting a suit with one or more random number generators, randomly selected a plurality of card draw thresholds with the random number generators and receiving wager information from a plurality of gaming tables via a communication device.

The method also includes incrementing a jackpot when the wager information indicates a qualifying wager has been placed, drawing a card from a deck of cards stored on a storage device when the jackpot crosses one of the plurality of card draw thresholds, inserting the card into a set of placed cards when the card is of the selected suit and presenting the set of placed cards and the jackpot at the plurality of gaming tables via a display. If the set of placed cards is a winning outcome, the jackpot is awarded.

A special card award may be awarded when the qualifying wager has been placed and the card drawn from the deck of cards has no suit. Alternatively or in addition, a placed card award may be awarded when the qualifying wager has been placed and the card drawn from the deck of cards is of the selected suit. The wager information may be received via one or more currency detectors at the plurality of gaming tables. Alternatively or in addition, the wager information may be received via one or more HIDs at the plurality of gaming tables. The jackpot may be awarded via a payout dispenser at the plurality of gaming tables.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an exemplary table bonusing system;

FIG. 2 illustrates an exemplary display of a table bonusing system;

FIG. 3A is a flow diagram illustrating operation of an exemplary table bonusing system;

FIG. 3B is a flow diagram illustrating operation of an exemplary table bonusing system;

FIG. 4 is a block diagram illustrating an exemplary controller;

FIG. 5 is a block diagram illustrating an exemplary client device;

FIG. 6 illustrates an exemplary HID;

FIG. 7 illustrates an exemplary HID;

FIG. 8 illustrates an exemplary currency detector;

FIG. 9 illustrates an exemplary currency detector sensors;

FIG. 10 illustrates an exemplary HID;

FIG. 11 is a flow diagram illustrating operation of an exemplary table bonusing system and a base game;

FIG. 12 illustrates an exemplary gaming machine;

FIG. 13 illustrates an exemplary gaming machine;

FIG. 14 is a flow diagram illustrating operation of an exemplary table bonusing system;

FIG. 15 is a side view of an exemplary card reader;

FIG. 16 is a top view of an exemplary card reader;

FIG. 17 is a flow diagram illustrating operation of an exemplary table bonusing system; and

FIG. 18 is a flow diagram illustrating determination of a contribution for incrementing a jackpot of an exemplary table bonusing system.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Generally speaking, the table bonusing system herein provides bonus games and awards for table games played with physical playing cards or other physical gaming indicia. The table bonusing system may be utilized with various base games, including blackjack, poker and other traditional table games. In addition, the table bonusing system will typically not meaningfully interrupt or slow game play of its base game. Also, the table bonusing system will typically automate payouts and reduce the risk of cheating. The table bonusing system may provide a bonus at one or more gaming tables of one or more gaming establishments.

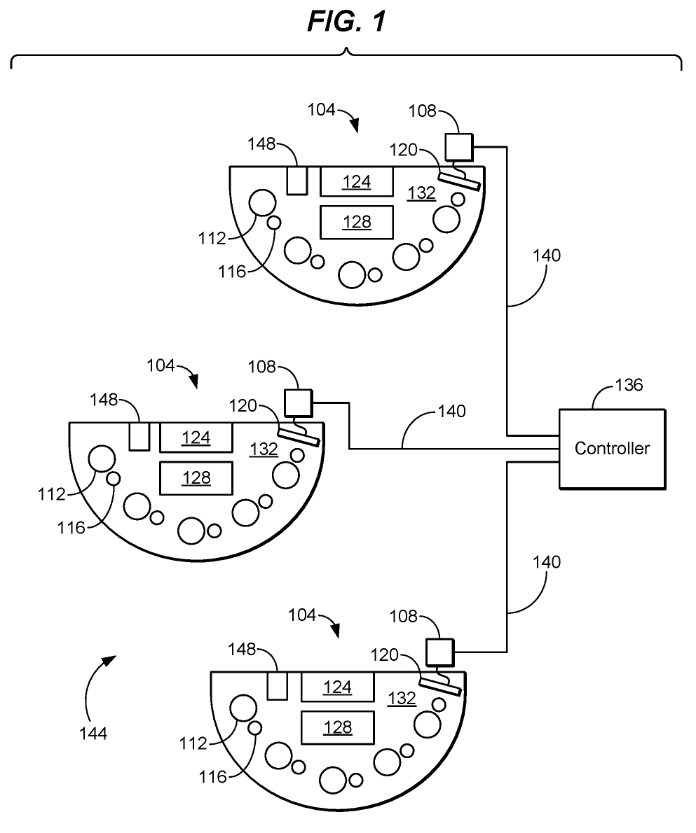

FIG. 1 illustrates an exemplary table bonusing system 144. As can be seen, a table bonusing system 144 may comprise one or more controllers 136 in communication with one or more gaming tables 104 via one or more wired or wireless communication links 140. It is contemplated that communication and such communication links 140 may be established across various networks, including local area networks, wide area networks, the Internet or the like.

Each gaming table 104 may have one or more client devices 108 to facilitate operation of the table bonusing system 144 at each gaming table. A client device 108 may be mounted to or otherwise associated with each gaming table 104. A display 120 that presents output from a client device 120 may be at each gaming table 104 as well. It is contemplated that a plurality of gaming tables 104 may share a single (typically large format) display 120 in some embodiments.

As can be seen, a gaming table 104 may comprise a playing surface 132, such as a felt or the like, upon which physical game implements may be placed during game play. Some exemplary game implements include game pieces, such as cards, dice, and markers. Game implements may also include currency, such as chips, cash, tokens or other items of value.

A playing surface 132 may include various areas, which may be delineated by lines, graphics or other indicators, or by their particular location on the playing surface. As shown in FIG. 1 for example, a playing surface 132 may comprise one or more dealer areas 124 and one or more player areas 112. A dealer and one or more players may position themselves at their respective areas or positions during game play. Game implements, currency or both may be received within a dealer area 124 and player area 112 during game play. Each player area 112 may have an adjacent or associated a side wager area 116, such as to receive currency when players wish to make a side wager. A community area 128 may be provided to receive one or more community game implements or community currency, such as community cards or a pot of currency for example.

A card shoe 148 may be provided to store a plurality of cards for dealing to players at the gaming table 104. In one or more embodiments, such cards will be used to play a base game at the gaming table. The table bonusing system 144 will typically include and provide its own electronic cards. The card shoe 148 may be placed on the table surface 132, such as shown. It is contemplated that a card shuffler may also be provided to randomize the cards.

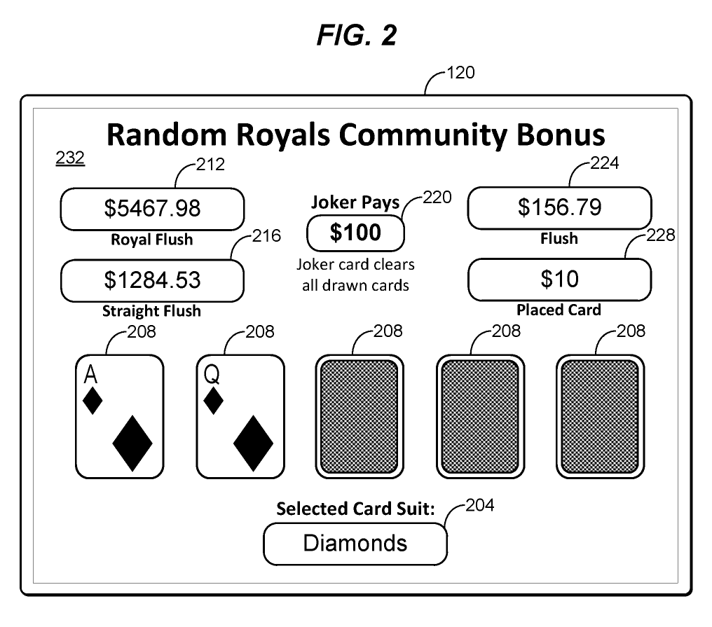

A display 120 may also be supported on or near the playing surface 132 in one or more embodiments. As can be seen from FIG. 1, a display 120 may be positioned to allow each player, a dealer or both to view the display. FIG. 2 illustrates an exemplary bonus game 232 presented by a display 120 of the table bonusing system 144. Various types of displays 120 may be used. For example, a display 120 may be an active matrix or segmented electronic display, such as a LCD, OLED or other monitor. Alternatively, it is contemplated that a display 120 may be an electromechanical device whereby currency values, game indicia or both may be presented via one or more rotating wheels.

A display 120 will typically present information relating to a bonus game 232 for a gaming table. In the exemplary embodiment of FIG. 2 for example, the display 120 is presenting a plurality of cards 208, a number of jackpots 212, 216, 224 and criteria for winning such jackpots (e.g., “Royal Flush,” “Straight Flush,” “Flush,” “Placed Card,” and “Joker Pays”) for a “Random Royals” bonus game 232. The display 120 also shows an active or selected suit 204 of the bonus game 232 as well. It is noted that the jackpots 212, 216, 224 may be incremented as game play at one or more gaming tables occurs, and that the display 120 may be updated in real time to reflect the current amount of a jackpot. Ancillary awards 220, 228 may also be presented on a display 120. Ancillary awards 220, 228 may be set by a gaming establishment or other operator and be fixed until reset to another value by the operator of the table bonusing system.

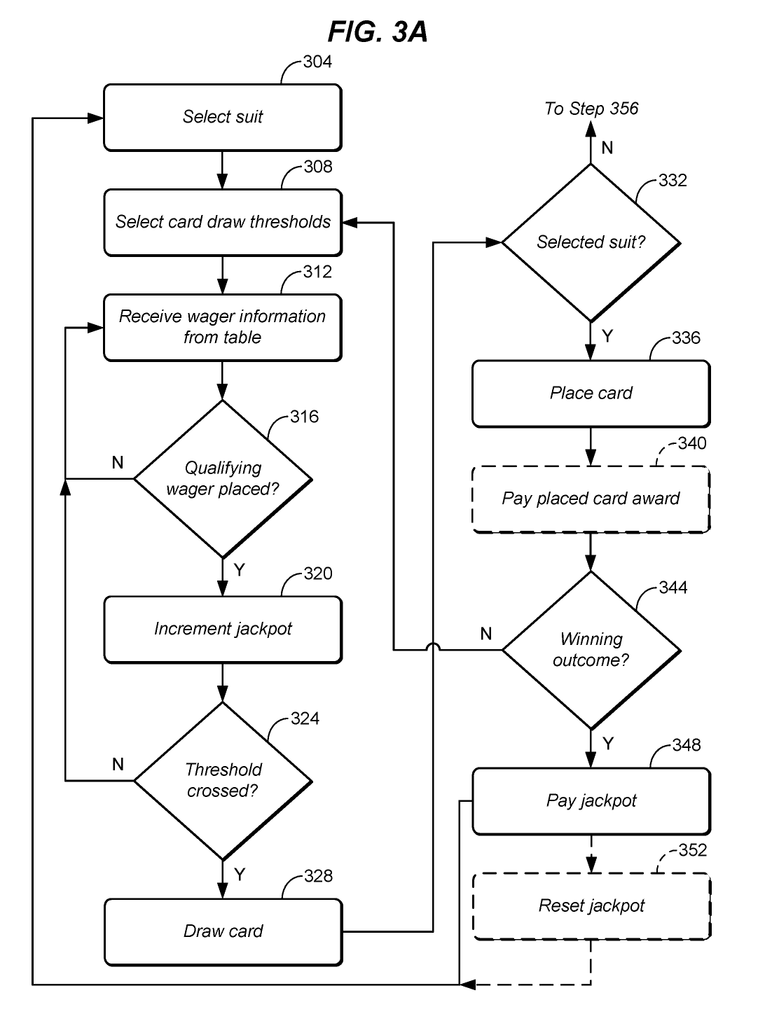

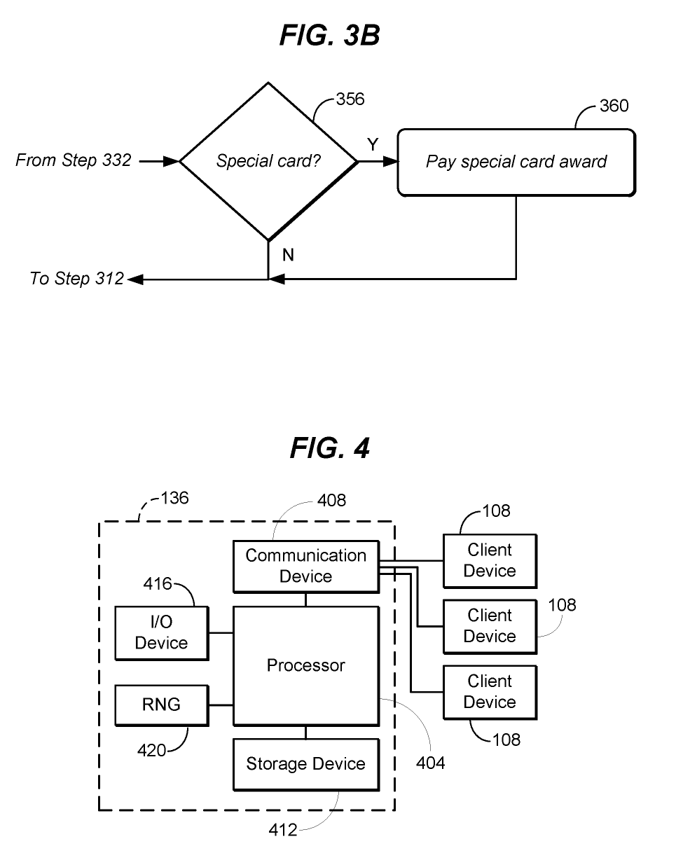

Operation of an exemplary table bonusing system will now be described with regard to the flow diagram of FIGS. 3A and 3B. Typically, the table bonusing system will fund and offer a bonus game including a jackpot as well as one or more ancillary awards to a plurality of players playing a base game at a plurality of gaming tables. Ancillary awards may be more easily achievable to provide consistent enticement for player so play the bonus game, such as by making qualifying wagers, as will be described further below. The table bonusing system does not require alteration of a base game's rules to operate.

In one or more embodiments, the bonus game will be a card game with a particular set of poker hands as its winning outcomes. To illustrate, the exemplary embodiment of FIG. 2 shows Royal Flush, Straight Flush and Flush as winning outcomes. Players can win a jackpot 212, 216, 224 by placing cards to form the required winning outcome. The bonus game may utilize a deck of cards comprising one or more shuffled 52 card decks. Each 52 card deck may have thirteen cards in four different suits, such as the traditional club, clover, heart and diamond suits. One or more joker cards may also be included in the deck of cards in some embodiments. The deck of cards may be stored in and shuffled by the controller.

At a step 304, a card suit may be selected. For example, a controller may utilize a random number generator to select a card suit. At a step 308, one or more card draw thresholds may be selected. Typically, the card draw thresholds will be selected via a random number generator as well. A card draw threshold may be a numerical value randomly selected from within at least one defined range. It is contemplated that an operator may define the range within which the card draw thresholds are selected, such as by inputting the range into a controller. This allows the operator to define the frequency at which a jackpot hits as well as the payback percentage, which affords the operator a great deal of flexibility.

At a step 312, the controller may receive wager information from a gaming table, such as via the gaming table's client device. Typically, wager information will comprise the amount of each player's side wager at a gaming table. Wager information may also or alternatively comprise the amount wagered at the gaming table's base game. Wager information will typically be generated during wagering activity of a base game. For example, players may be provided with an opportunity to make a side wager or other qualifying wager for the table bonusing systems bonus game during a first or other wagering round of a blackjack, poker or other base game. As will be described further below, wager information may be inputted manually, such as by a dealer, or automatically detected by one or more currency detectors at the gaming table.

At a decision step 316, if the wager information indicates qualifying wager has not been placed, the process may return to step 312 to receive additional wager information. If the wager information does indicate a qualifying wager has been made, then the jackpot may be incremented at a step 320. A display may be updated to reflect the increased jackpot value. Various criteria may be used to find that a qualifying wager has been made. For example, a side wager may be deemed a qualifying wager. Alternatively or in addition, a base game wager above a particular amount may be deemed a qualifying wager.

At step 320, the jackpot may be incremented according to a predefined increment rate. An increment rate may be a percentage of a qualifying wager or a fixed value for example. It is contemplated that an operator may set the increment rate at the controller in one or more embodiments.

At a decision step 324, it is determined if the jackpot has crossed one of the card draw thresholds. If not, the process may return to step 312 to receive additional wager information. If the jackpot has crossed a card draw threshold, a card may be drawn from the deck of cards at a step 328. At a decision step 332, it is determined if the drawn card has the same suit as the selected suit. If the drawn card is of the selected suit (i.e., has the same suit as the selected suit), the drawn card may be placed at a step 336. To illustrate, in FIG. 2, the selected suit is diamonds and it can be seen that the set of placed cards includes the Ace and Queen of diamonds cards 208.

At an optional step 340, an ancillary award may be paid. In this case, a placed card award may be paid. As can be seen from FIG. 2, a placed card award 228, may have a defined amount that is paid to the player whose qualifying wager caused a card 208 to be placed. A placed card award is beneficial in that it provides enticement to players to make qualifying wagers even when there are no placed cards or just a few placed cards.

At a decision step 344, it is determined whether the placed cards form a winning outcome. In one or more embodiments, a winning outcome is a predefined hand, such as a Royal Flush, Straight Flush or Flush, as shown in FIG. 2. Players are guaranteed at least a Flush because only cards of the selected suit can be placed. It is estimated that a Flush outcome will occur approximately 60% of the time in one or more embodiments.

If a winning outcome is achieved at decision step 344, then the corresponding jackpot may be paid at a step 348. For example, with regard to FIG. 2, if a player achieves a Royal Flush, the royal flush jackpot 212 would be paid. Likewise, achievement of a Straight Flush or Flush would result in the straight flush award 216 or flush award 224 being paid, respectively. The jackpot would be paid to the player that caused the card that completes a winning outcome to be placed by their qualifying wager.

It is contemplated that, in some embodiments, a winning outcome may be achieved including one or more cards from a base game and the placed cards. To illustrate, a player may be awarded a jackpot if the physical playing cards they hold and the placed cards, in combination, form a winning outcome.

At a step 352, the jackpot may be reset, such as to zero or a predefined base value. The deck of cards may also be reset, such as by generating a new shuffled deck of cards. In addition, all placed cards may be removed. Thereafter, the process may return to step 304 to offer a new bonus game to players.

In one or more embodiments, a special card award may be paid. As can be seen from FIG. 2, a special card award 220 may be paid when a special card is drawn from the deck of cards. The special card will typically not have a suit, such as a Joker card, and therefore be distinct from the other cards in the deck of cards. At decision step 332, if the drawn card is not of the selected suit, it may be determined whether a special card award is to be paid. Referring to FIG. 3B, at a decision step 356, if the drawn card is a special card, a corresponding special card award may be paid at a step 360. Similar to the other ancillary awards (and jackpot) above, the special card award is paid to the player that cause the special card to be drawn from the deck of cards by their qualifying wager. If the drawn card is not a special card at decision step 356, or after the special card award is paid at step 360, the process may return to step 312 to receive additional wager information.

A special card award may have a different value depending on how it was achieved in some embodiments. For example, a special card award may be adjusted (i.e., increase or decrease) based on its position in the deck of cards. In one embodiment, a special card award may be increased when it is first in the deck of cards.

It is contemplated that, in some embodiments, multiple cards may be drawn at step 328. For example, in one embodiment, if there are currently three placed cards, two cards may be drawn at step 328 to complete a poker hand. In operation, cards may be repeatedly drawn from the deck of cards until the two cards are placed at step 336 to complete the poker hand. This is advantageous in situations where the three placed cards indicate the possibility of a royal flush in that it provides enticement for players to make qualifying wagers rather than waiting for the fourth placed card before doing so.

In another embodiment, even more cards may be drawn at step 328. It is contemplated that an entire hand of cards may be drawn for example. In operation, cards may be repeatedly drawn from the deck of cards until an entire hand of the selected suit is placed at step 336. A jackpot may be rapidly and repeatedly awarded in such an embodiment.

FIG. 4 illustrates an exemplary server or controller 136 of the table bonusing system. As can be seen, a controller 136 may comprise one or more processors 404, one or more storage devices 412, and one or more communication devices 408. A processor 404 may be a microprocessor, microcontroller, or the like that executes instructions to provide the controller functionality disclosed herein. For example, a processor 404 may execute instructions to provide the operation disclosed with regard to FIGS. 3A and 3B in one or more embodiments. It is noted that the instructions may be stored on a storage device 412 for retrieval and execution by a processor 404, or may be hardwired into a processor.

A storage device 412 may also store data related to a bonus game. For example, a storage device 412 may store jackpot values, ancillary award values, winning outcomes, card draw thresholds, one or more decks of cards, and placed cards. A storage device 412 may store data in various ways. For example, a storage device 412 may comprise solid state memory, RAM, ROM, optical storage, magnetic storage or various subsets thereof. It is noted that one or more storage devices 412 may be part of a processor 404 in some embodiments.

One or more communication devices 408 allow a controller 108 to communicate data with other devices, such as one or more client devices 108. For example, a communication device 408 may receive wager information from one or more client devices 108, and transmit jackpot values and placed cards to the client devices. Client devices can then update their displays with jackpot values and placed cards. A communication device 408 may communicate data via one or more wired or wireless communication links. It is noted that communication may occur locally, such as on a local area network, or across longer distance, such as on a wide area network or the Internet. This allows a large variety of players to play the bonus game provided by a single table bonusing system.

One or more random number generators 420 will typically also be part of a controller 136. A random number generator 420 may be a separate component, such as shown, or may be integrated into a processor 404 of a controller 136. A random number generator 420 may be used where randomization is desired, such as when shuffling a deck of cards, selecting a selected card suit, and selecting card draw thresholds.

One or more I/O devices 416 may also be included in a controller 136. An I/O device 416 generally allows data input, data output or both, typically from a peripheral device and may communicate via a wired or wireless connection. For example, an I/O device 416 may be a USB port or BLUETOOTH transceiver that connects to a keyboard, mouse, touchscreen or other human input device (HID). An I/O device 416 may be a graphics port as well, such as one that connects to a display. An I/O device 416 may be used to receive input and provide output to an operator, such as to setup, maintain, check status of, diagnose or repair a controller 136.

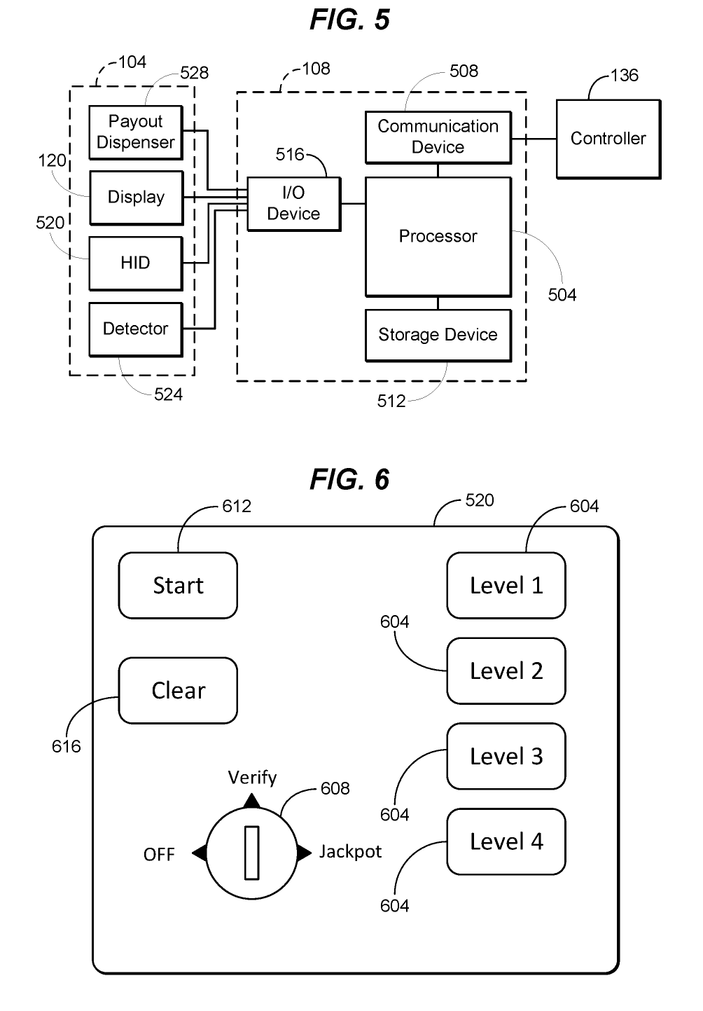

FIG. 5 illustrates an exemplary client device 108. As described above, a client device 108 may be mounted to or otherwise associated with a gaming table 104. A client device 108 can then report or transmit information generated at its gaming table 104, such as wager information, to a controller 136.

A client device 108 may comprise one or more processors 504, one or more communication devices 508, one or more memory devices 512 and one or more I/O devices 516. A processor 504 may execute instructions to provide the client device functionality disclosed herein. For example, a processor 504 may execute instructions that capture and transmit wager information to a controller 136 and present a bonus game on a display 120 based on information received from the controller. Referring to FIG. 2 for example, a client device 108 is displaying cards 208 (placed and unplaced), jackpots 212, 216, 224 and ancillary awards 220, 228.

A communication device 508 may communicate information with a controller 136 via a wired or wireless communication. As described above, communication between a controller 136 and client device 108 may occur via one or more local area, wide area or other networks in one or more embodiments. In operation, a communication device 508 may transmit wager information and receive bonus game information, such as placed cards, jackpot values and ancillary award values.

One or more storage devices 512 may store the instructions executed by the processor 504 as well as data related to a bonus game. For example, a storage device 512 may locally store jackpot values and ancillary award values received from a controller 136. A data storage device 512 may also or alternatively store data related to a gaming table 104, such as the number of players and wager information inputted or detected for each player. Some exemplary storage devices 512 include solid state memory, RAM, ROM, optical storage and magnetic storage.

One or more I/O devices 516 will typically be provided to send data, receive data or both with one or more peripheral devices. For example, a display 120 may be connected to an I/O device 516 comprising a display port to display a bonus game 232, such as shown on the display of FIG. 2. An I/O device 516 may communicate via a wired or wireless connection. Some exemplary I/O devices 516 include USB ports, serial ports, parallel ports, BLUETOOTH transceivers and the like.

An I/O device 516 may communicate with other peripheral devices as well. For example, a HID 520 may be connected to an I/O device 516 comprising a USB or other port. A dealer may utilize a HID 520, such as a keypad or touchscreen, to input wager information associated with players at the dealer's table in one or more embodiments. It is contemplated that players may themselves input wager information in some embodiments. In such case, a HID 520 may be provided to each player or at each player area. Alternatively, it is contemplated that a plurality of players may utilize the same HID 520.

One or more detectors 524 may also or alternatively be connected to an I/O device 512. For example, a detector 524, such as a currency detector, game implement detector or both, may be connected to an I/O device 512 comprising a USB or other port. A detector 524 may detect currency on a table surface and generate wager information based on the same. For example, a detector 524 may detect the amount wagered at a player area, side wager area or both and generate wager information include the same. It is contemplated that wager information may include whether a wager is a qualifying wager or not, as may be determined by a processor 504 executing instructions to determine the same.

A peripheral device may also be a payout dispenser 528, such as a ticket printer, currency or chip dispensers or both, used to payout a jackpot or ancillary award in one or more embodiments. For example, a voucher redeemable for a jackpot or ancillary award payment may be printed by a ticket printer. Alternatively, a currency or chip dispenser may provide a payout in currency or chip form.

FIG. 6 illustrates an exemplary HID 520 for use by a dealer. In one or more embodiments, a dealer may input information to a table bonusing system via a HID 520. Typically, such input will be relayed or transmitted to a controller via a HID's client device. As can be seen, a HID 520 may include one or more controls, such as buttons, switches, knobs and the like. In the embodiment of FIG. 6 for example, the HID 520 includes a “Start” button 612, a “Clear” button 616 and a keyed knob 608. In operation, a dealer may engage a start button 612 to indicate that a new base game has started. A clear button 616 may be engaged to indicate that a base game has ended.

A keyed knob 608 may be moved between multiple positions, such as to deactivate or turn off a client device, or to select a verification or jackpot state. To illustrate, a dealer (or other personnel) may turn a keyed knob 608 to a verify position to indicate that a winning outcome for a jackpot has been achieved. The dealer or operator may then verify the winning outcome. Once verified, the dealer may turn the keyed knob 608 to a jackpot position to indicate that the winning outcome has been verified and that the jackpot should be paid. This may cause a client device to signal the operator to pay the winning player the jackpot. Alternatively, the jackpot may be paid automatically, such as via a ticket printer or currency dispenser, once the keyed knob 608 is in the jackpot position. A keyhole in the keyed knob 608 limits use of the keyed knob to those with a proper key.

One or more additional controls 604 may be provided as well to allow a dealer to input various other information. For example, wager information for individual players may be received from a dealer via a control 604.

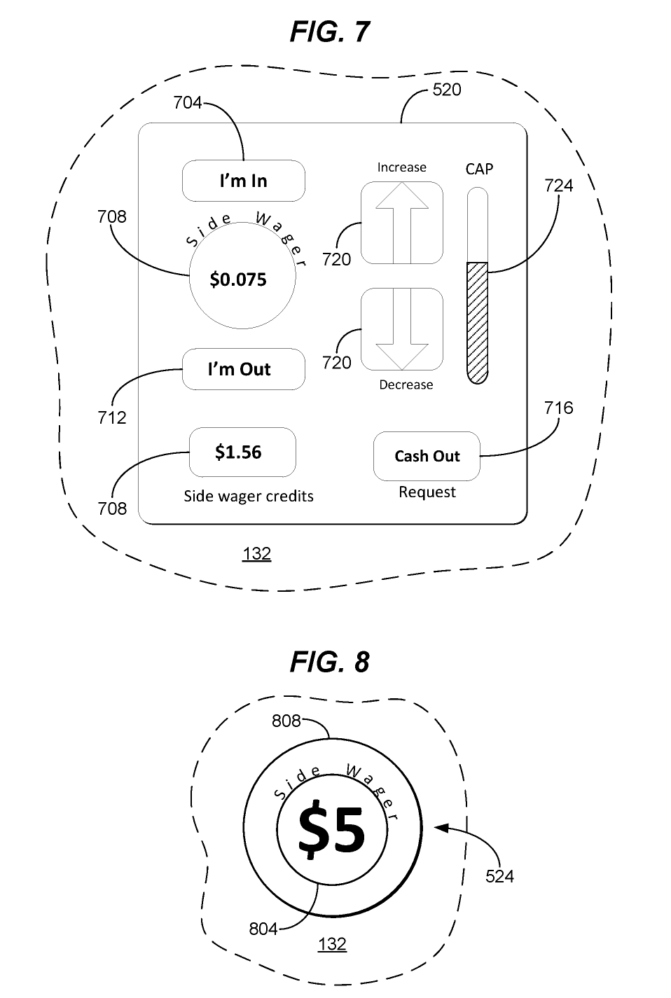

FIG. 7 illustrates an exemplary HID 520 for a player. As can be seen, a HID 520 may be at a table surface 132 to receive and present information to one or more players. In the exemplary embodiments of FIG. 7, the HID 520 includes one or more indicators 704, 708, 724 that present information. An indicator 708, 724 may comprise a LCD, LED or other screen, display or readout for example. As can be seen, an indicator 708 may present currency values, such as the amount of a side wager or credits available for side wagers. An indicator 724 may also present minimum or maximum side wager amounts.

One or more controls may also be included. As shown in FIG. 7 for example, an “I'm In” button 704 and an “I'm Out” button 712 are shown to allow a player to respectively indicate whether they wish to participate in a side wager. Engaging the “I'm In” button 704 may automatically place a minimum side wager, while engaging the “I'm Out” button 712 may cancel a side wager (assuming bonus game play is not currently active). Toggle switches or buttons 720 may be provided to increase or decrease a side wager.

It is contemplated that any winnings from a bonus game provided by the table bonusing system, such as jackpot or ancillary award payouts, may be accumulated as currency credits in some embodiments. A particular player's current credits may be shown on an indicator 708, such as described above. If a player wishes to cash out their credits, the player may engage a “Cash Out” button 716. Thereafter, a ticket printer, currency dispenser or gaming establishment personnel may be signaled to provide payment to the player.

As stated, input from a player may be received at a HID 520 and transmitted to a controller via the HID's client device. In addition, various information may be received from a controller via the HID's client device for presentation on the HID 520. For example, a player's current credits may be received from a controller for presentation on an indicator 708 of a HID 520.

A HID 520 may be in or at a table surface 132 and may be positioned at each player area on a table surface. In this manner, each player may utilize their own HID 520. It is contemplated that a HID 520 for a dealer may be positioned at a dealer area, at a client device or mounted to a gaming table.

FIG. 8 illustrates and exemplary currency detector 524. In general, a currency detector 524 will detect whether a wager has been placed, the amount of a wager or both. In one or more embodiments, a currency detector 524 may comprise one or more indicators 808, one or more sensor areas 804 or both. An indicator 808 may comprise one or more screens or lights provided to indicate whether a wager has been detected. In the exemplary embodiment of FIG. 8 for example, the indicator 808 is a light up ring around the sensor area 804 of the currency detector 524. When a wager is placed at the sensor area 804, the indicator 808 is activated. If no wager is placed at the sensor area 804, the indicator 808 is deactivated.

A currency detector 524 may be on or in a table surface 132. Typically, a currency detector 524 will be positioned at a player's side wager area such that each player may have their own currency detector. In operations, a currency detector 524 may transmit wager information indicating whether a wager has been detected, the amount of a wager at its sensor area 804, or both.

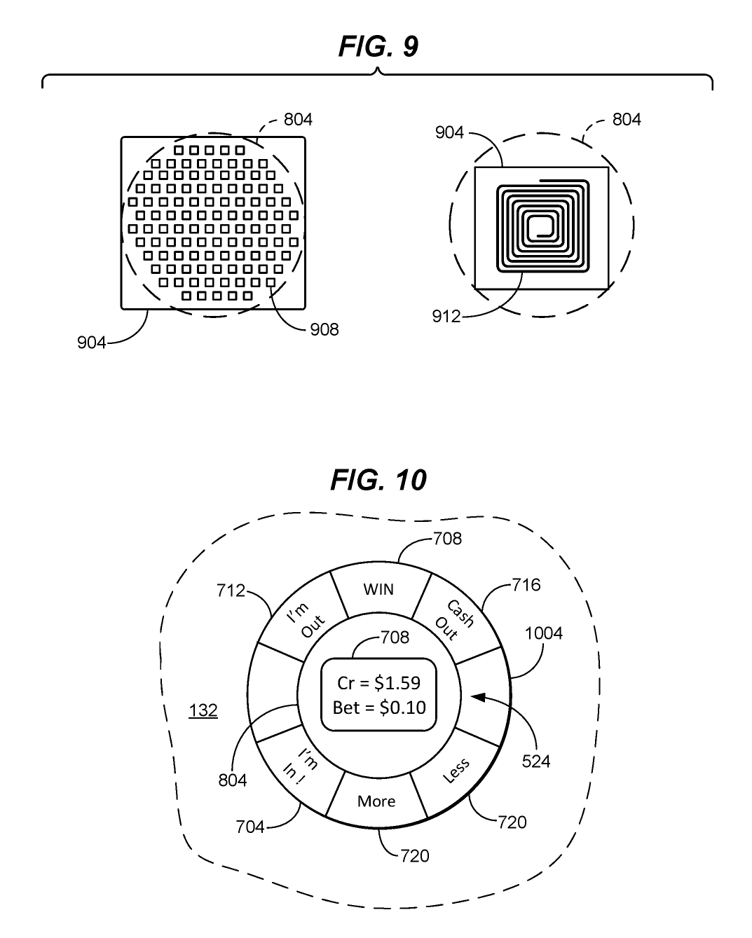

FIG. 9 illustrates exemplary sensors 908, 912 for a currency detector. As can be seen, sensors 908, 912 may be mounted to a substrate 904, such as a circuit board, and be positioned within a sensor area 804 of a currency detector. Typically, the sensors 908, 912 will be positioned below the top cover or surface of a currency detector. As can be seen from FIG. 8, the top cover may bear one or more informative markings, such as to assist players.

Various types of sensors 908, 912 may be utilized. As can be seen on the left side of FIG. 9, a currency detector may comprise an array of optical sensors 908 that may detect light levels, capture images or both. Light levels may be used to determine whether a wager is present or absent, with lower light levels indicating the presence of a wager. Captured images may also be used to determine whether a wager has been placed, the amount of a wager or both, such as through optical character or object recognition.

Another exemplary type of sensor is shown on the right side of FIG. 9. Namely, a sensor may comprise an RFID reader 912 that detects radio frequency transmissions from currency, such as RFID enabled chips or tokens. An RFID reader 912 may emit and receive radio frequency signals to detect whether a wager has been placed, the amount of a wager or both.

FIG. 10 illustrates an exemplary HID 1004 that includes a currency detector 524. As can be seen, such a HID 1004 may include a plurality of controls for receiving input as well as a sensor area 804 for detecting wagers. One or more indicators 708 may also be provided to present information. Typically, such a HID 1004 will by at or in a table surface 132 and be installed at one or more side wager areas of a table surface.

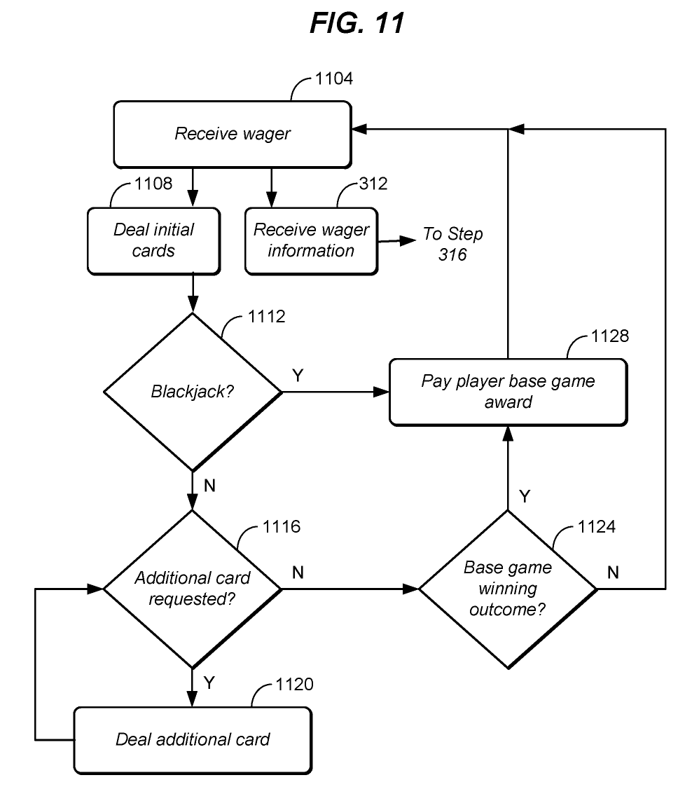

Exemplary operation of the table bonusing system in conjunction with a base game will now be described with regard to FIG. 11. Though described with regard to blackjack as the base game, it will be understood that various other table games may be used as base games. At a step 1104, a wager may be received from a player to begin the blackjack game. For example, a player may place a wager at their player area, side wager area or both.

At a step 1108, an initial set of cards may be dealt to the player. Simultaneously, wager information may be received at a step 312, such as via manual input at a HID, or via one or more currency detectors. As can be seen, the table bonusing system independently proceeds to determine if the wager information indicates a qualifying wager was placed at step 316 of FIG. 3. As described above, a qualifying wager may be a separate side wager or a base game wager that meets particular criteria. The bonus game may independently continue at the table bonusing system as disclosed with regard to FIG. 3 above to determine increment a jackpot as well as award any winning outcomes for the jackpot and any ancillary awards.

If the player's qualifying wager generates a winning outcome or ancillary award at the bonus game, it is contemplated that the player may be notified and paid immediately, after a predefined delay or upon completion of the base game, such as when losing wagers are collected and winning wagers are paid in a base game. To illustrate with respect to FIG. 11, a blackjack base game may be deemed completed at a step 1128 where any base game winning outcomes are paid, as will be described further below. Notification may occur via a client device's display or via an indicator of a HID in one or more embodiments.

As can be seen from FIG. 11, in the meantime, the blackjack game proceeds independent of the bonus game to a decision step 1112 where it is determined whether the player has achieved 21 or blackjack. If so, the player may be paid for their base game winning outcome at a step 1128. This may occur by dispensing or otherwise providing currency or vouchers to the player.

Typically, a player is paid based on the amount of their wager. For example, a player may be paid an amount equal to their base game wager, even when a portion of the base game wager is used to increment a jackpot of the table bonusing system. Achieving a blackjack at decision step 1112 may pay extra in some embodiments.

If the player has not achieved a blackjack, the base game may continue at a decision step 1116 where it is determined if the player wishes to receive another card. If so, the player is dealt an additional card at a step 1120. The player may request and receive additional cards at the players discretion, or until the player busts by going over 21.

Once additional cards are no longer requested, it may be determined whether the player has a base game winning outcome at a decision step 1124. In general, a winning outcome in the blackjack base game of FIG. 11 is a hand that is larger than a dealer's hand while being less than or equal to 21. Determination of a winning outcome may be delayed until a dealer's hand is completed. If the player has achieved a winning outcome at decision step 1124, then the player may be paid at step 1128. As stated, the player will typically be paid based on the amount of their base game wager, such as an amount equal to the player's base game wager.

As can be seen, the table bonusing system does not interfere or delay a base game since its disposition is independently determined. This is advantageous in that the table bonusing system does not change the rules of a base game but still allows a bonus game with multiple jackpot or ancillary award opportunities to be provided at a gaming table.

It is contemplated that the table bonusing system may interoperate with one or more electronic table games, one or more gaming tables (such as described with regard to FIG. 1), or both. Namely, in addition to client devices at gaming tables, electronic gaming machines may connect to and participate in a bonus game offered by the table bonusing system.

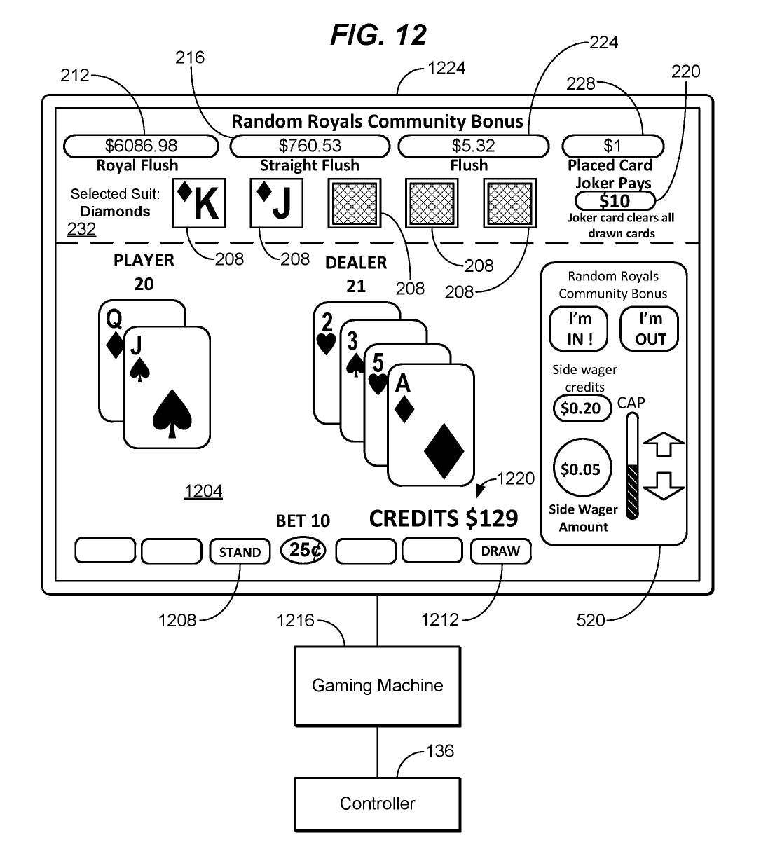

Referring to FIG. 12 for example, it can be seen that an electronic gaming machine 1216 offering a base game 1204 via its display 1224 may be connected to a controller 136 of the table bonusing system. A bonus game 232 may be presented along with a base game 1204 on a display 1224. In addition a HID 520 may be presented on a display 1224 as well.

Bonus game information, such as placed cards, jackpot values and ancillary award values may be transmitted to a gaming machine 1216 from a controller 136, while wager information may be transmitted to the controller 136 from the gaming machine 1216. A player may utilize a HID 520 to input wager information for a bonus game 232, as described above. Alternatively, a side wager button or the like may be provided to allow a player to submit a qualifying wager. In addition, it is contemplated that base game 1204 wagers meeting particular criteria may be deemed qualifying wagers, as described above.

As can be seen, in the exemplary embodiment of FIG. 12 an electronic blackjack game is the base game 1204. The base game 1204 includes buttons for playing the game, such as the “Stand” button 1208 and “Draw” button 1212 shown. It will be understood that the buttons may change depending on the state of the base game. For example, “Bet” or “Cash Out” buttons may be provided.

A credit indicator 1220 will typically be provided to show a player's available credits or currency. It is contemplated that a credit indicator 1220 may include winnings from a base game 1204 as well as a bonus game 232. In this manner, any jackpots or ancillary awards from a bonus game 232 also update a credit indicator 1220. In some embodiments, a separate credit indicator 1220 may be provided for a bonus game 232.

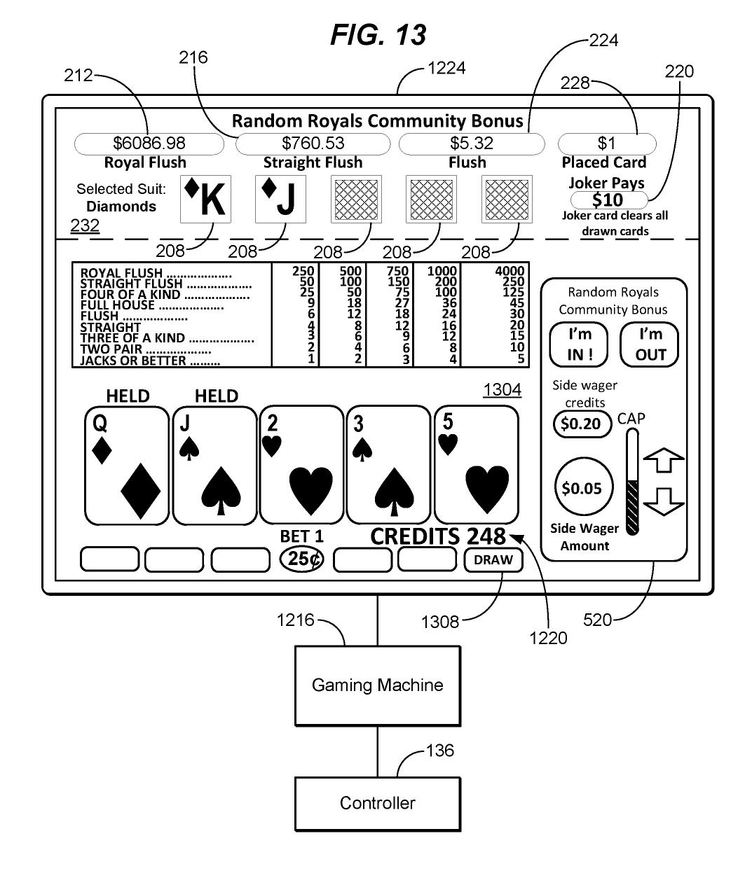

FIG. 13 illustrates another exemplary electronic table game. In this embodiment, the base game 1304 is a video poker game. Similar to the base game 1204 of FIG. 12, one or more buttons, such as a “Draw” button 1308 may be provided to facilitate play of the base game 1304. Likewise, a bonus game 232, HID 520 or both may be presented via a display 1224 along with a base game 1304.

As described above with regard to the flow diagram of FIG. 11, the table bonusing system does not interfere with or delay a base game. This is true for electronic base games as well, such as the electronic table games of FIGS. 12 and 13. For instance, once wager information is received at an electronic base game, a table bonusing system may independently provide a disposition for its jackpot and ancillary awards. The electronic base game may simultaneously and independently proceed to its own disposition.

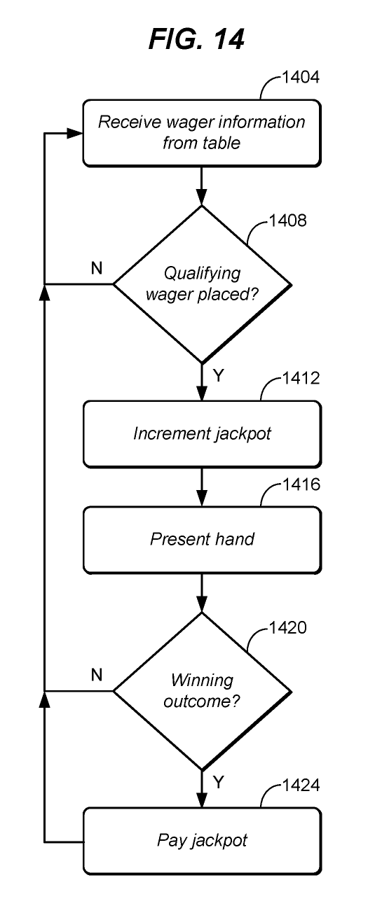

It is noted that a variety of bonus games may be provided by the table bonusing system. FIG. 14 is a flow diagram illustrating operation of an exemplary bonus game having a jackpot award. At a step 1404, wager information may be received from a gaming table, such as via a client device of the gaming table. For example, wager information may be received via a currency detector or HID, such as disclosed above.

At a decision step 1408, it may be determined whether a qualifying wager has been placed. In one or more embodiments, the wager information may be transmitted to a controller, and the controller may determine if a qualifying wager has been placed. If a qualifying wager has not been placed, the process may return to step 1404 to receive additional wager information. As disclosed above, wager information may be generated during wagering rounds of a base game.

If a qualifying wager has been placed at decision step 1408, the jackpot may be incremented at a step 1412. At a step 1416, a hand of cards may be presented. Typically, this will occur at a display of one or more gaming tables in communication with the controller. In operation, the controller may randomly generate a hand of cards and transmit the same to one or more client devices for presentation on their associated displays.

At a decision step 1420, if the hand is a winning outcome, the jackpot may be paid at a step 1424. This may occur via a payout dispenser at one or more gaming tables. If the hand is not a winning outcome, the process may return to step 1404 to receive additional wager information. Though described with regard to cards, it is contemplated that the controller may generate various gaming indicia. If such indicia match one or more predefined winning outcomes, the jackpot may be paid at step 1424.

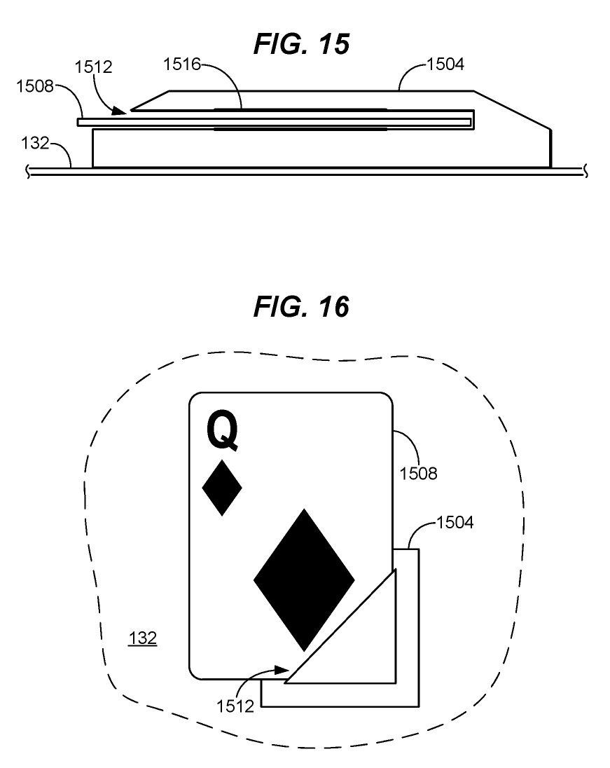

In another alternate embodiment, a bonus game may utilize physical playing cards from a base game in addition to cards of the bonus game. One exemplary embodiment of such a bonus game is described above with regard to step 344 of FIG. 3. As shown in FIG. 15, a gaming table may have one or more card readers 1504 capable of detecting and reading physical gaming implements, such as cards, and generate implement information describing the same. A card reader 1504 may detect the suit and value of a card 1508, and generate implement information including the suit, value or other characteristic of a gaming implement for example. A card reader may be installed at the table surface 132 of a gaming table in one or more embodiments.

A card reader 1504 may comprise one or more sensors 1516, such as optical sensors or RFID readers. In one embodiment, a card reader 1504 may include a slot 1512 for receiving at least a portion of a card 1508. One or more sensors 1516 may be at the slot 1512 and detect inserted cards, read inserted cards or both. It is contemplated that a plurality of card readers 1504 may be provided at a particular gaming table.

In operation, card readers 1504 may generate card implement information identifying cards in player hands, community cards, dealer cards, discarded cards and the like. The implement information may be transmitted to a client device, such as by connection with the client device's I/O device. A card reader 1504 may function as a peripheral device in this manner. The implement information may be transmitted to a controller by the client device. Thereafter, the controller may utilize the implement information along with placed cards of its bonus games to determine if a winning outcome has occurred.

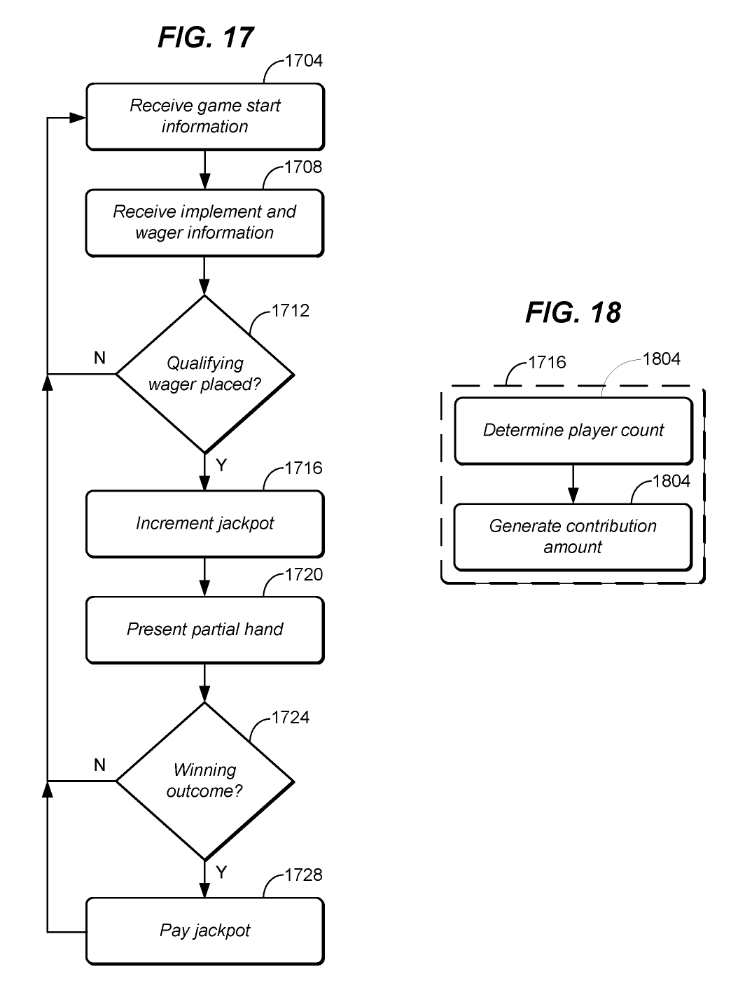

FIG. 17 is a flow diagram illustrating operation of another exemplary bonus game of the table bonusing system, whereby a winning outcome is determined based on a combination of one or more base game cards in play at a gaming table, and one or more placed cards presented by the table bonusing system. At a step 1704, game start information may be received from a gaming table. For example, a dealer may engage a “Start” button or other control on their client device, which then transmits the game start information to a controller of the table bonusing system.

Game start information indicates to the table bonusing system that a new base game has started at the gaming table. In addition, game start information may cause a controller to reset for a new bonus game. For example, receiving game start information may cause a controller to expect implement and wager information, shuffle its deck of cards and clear any existing partial hand, or various subsets thereof.

In one or more embodiments, game start information may also include information to facilitate operation of the bonus game. For instance, game start information may include a player count (i.e., the number of players at a gaming table), what base game is being played, or both.

At a step 1708, implement information and wager information from the gaming table may be received at the controller. As described above, implement information identifies the physical gaming implements in play in the base game. In one or more embodiments, implement information may identify what physical cards have been dealt to players, the dealer or both. Implement information may include a player identifier that associates cards a player holds to that particular player, such as by player position. Likewise, wager information may include a player identifier that associates the wager(s) a player placed to that particular player position.

One or more card readers may generate the implement information. It is contemplated that individual card readers may be at each player position to identify and associate base game cards for each player. A controller may determine progress of a base game utilizing such implement information. Alternatively, it is contemplated that a dealer or other personnel may provide input to ensure cards identified by a card reader are properly associated with the player that holds them.

At a decision step 1712, if it is determined that a qualifying wager was not placed based on the wager information, the process may return to step 1704 to await a new game start signal. If, at decision step 1712, a qualifying wager was placed, the bonus game's jackpot may be incremented at a step 1716.

At a step 1720, a partial hand may be presented to players at the gaming table. As stated, this may occur by placing the partial hand on a display at the gaming table. The partial hand will typically be randomly generated by the controller and transmitted to the gaming table. A partial hand may comprise a set of placed cards or other gaming implements. Typically, the partial hand will contain enough gaming implements such that, when combined with a player's base game gaming implements, the combined hand can qualify as a winning outcome of the bonus game (i.e., is a complete hand with respect to the bonus game).

At a decision step 1724, it may be determined if the combined hand is a winning outcome. If the combined hand is not a winning outcome, the process may return to step 1704 to await a new game start signal. If the combined hand is a winning outcome, the jackpot may be paid at a step 1728. As described above, the jackpot may be paid in various ways, such as by a payout dispenser at the gaming table or by payment provided manually by a dealer.

Determination of whether a winning outcome has occurred will typically be made by the controller. In some embodiments, a dealer or other personnel may determine whether a winning outcome has occurred however. In such embodiments, card detectors are not required and may not be provided at gaming tables. Implement information may be inputted manually at a client device by a dealer in such embodiments. Alternatively, implement information may not be provided or used at all.

It is contemplated that a client device or controller may assist a dealer by displaying which winning outcomes are possible to achieve based on the current set of placed cards and base game cards. For example, two same-suited sequential cards could potentially become a Flush, Straight Flush or a Royal Flush. These potential winning outcomes may be presented to a dealer, one or more players or both. For example, a HID indicator or display may present a list of potential winning outcomes for a bonus game as determined by a client device or controller. Referring back to the example above, if the sequential cards are a low number a Royal Flush would no longer be possible and the list of potential winning outcomes may be accordingly amended on an indicator or display.

In one particular exemplary embodiment, the base game may be a blackjack game and the bonus game may be a poker type game. In such embodiment, game start information may be received at step 1704 when a new blackjack game starts. Each player may wager and be dealt two cards for the blackjack game. This generates implement and wager information which may be received at step 1708.

At decision step 1712, it may be determined which players made a qualifying wager, and the bonus game's jackpot may be incremented accordingly at a step 1716. A partial hand may be generated by a controller 136, such as of FIG. 1, and presented at step 1720. In this embodiment, the partial hand may be a set of three cards (to form a complete poker hand for each player). It is contemplated that a single set of three cards may be presented, or that each individual player may be presented with their own individual set of three cards. At decision step 1724 a combined hand, including each player's cards from the base game or a subset thereof (such as the two initially dealt cards) and the cards of the partial hand, is evaluated. At step 1728, each player that has achieved a winning outcome may be paid a portion of the jackpot or the complete jackpot.

Various strategies for funding bonus games, such as progressive jackpots, that are awarded when more than one player achieves the same winning outcome may be implemented. In many cases, a progressive jackpot comprises a base pay, or reset value, and additionally an increment contribution, which is funded at step 1716 as each round of game play commences. The base pay is funded intrinsically by the odds making of the paytable, and therefore, multiple awards to players who complete a winning outcome in the same round are intrinsically funded by such coincidence, (i.e., the long term average of the game payback expectation remains static).

However, a traditional progressive contribution increases the jackpot by a fixed percentage of total wagers; such contribution is summed to the base payout and is viewed by all players simultaneously. Therefore, the traditional method of implementing progressive contribution is only funded for the benefit of a single jackpot paid to a single winner. In a traditional progressive, after a single winner is paid a progressive jackpot, the next subsequent winner can expect a jackpot equal to or approximately equal to the reset base payout value.

Since the odds of simultaneous winners of large progressive jackpots is very small, so this funding inequity is not contemplated or perceived as a problem. In a game embodiment where a significant portion of winning cards are shared by more than one player, the odds of simultaneous winners of large progressive jackpots may be much greater. Therefore a predicament is created whereby the first player dealt by the dealer always wins the total progressive jackpot, and any subsequent or other winner is only paid a base pay value. This predicament is not acceptable for live table game applications since this places a severe inequity to all player positions other than the first position dealt by the dealer.

With the table bonusing system herein all players can be paid the same (total) progressive or other bonus game jackpot when all such players achieve the same winning card combination (or same winning rank) in the same round of base game play (21 or blackjack as an example). In other words, the table bonusing system may support multiple payouts of the same progressive jackpot value while also maintaining the operator's ability to easily configure the amount of funds that contribute, or fund, the progressive portion of a progressive jackpot.

As shown in the exemplary embodiment of FIG. 18, a jackpot may be incremented to support multiple jackpot winners. In one or more embodiments, a jackpot may be incremented by a contribution, defined as a percentage of total wagers (i.e., increment rate) divided by a player count, where the player count is the average number of players wagering on a progressive jackpot at a gaming table. The contribution may be determined or generated when a jackpot is incremented. To illustrate, in FIG. 18, the contribution is generated at the jackpot incrementing step of FIG. 17, step 1716.

A player count may be determined at a step 1804, such as by a controller. A controller may track the number of players at gaming tables and generate an average across the number of gaming tables. The number of players at a gaming table may be received by a controller in various ways. For example, the number of player may be manually inputted, such as via a HID, the wager information may indicate the number of players, or one or more card readers, currency detectors or other sensing devices may automatically detect and transmit the number of players at a gaming table to a controller, such as via a client device of the gaming table.

At a step 1808 the contribution to a jackpot may be generated based on the player count. To illustrate, if a two percent contribution is made to fund a specific bonus game jackpot prize pool, and there are on average four players per table, then the jackpot will increase by 2/4 percent, or 0.5%. In this manner, the progressive jackpot is fully funded on average as multiple players win the progressive award in a given game round. In another embodiment, the progressive contribution may maintain an implicit player average by dividing the progressive contribution collected in a specific round by the total number of active players in the game round. In both embodiments, over the long average, the progressive jackpot is fully funded in the case that multiple players win the same jackpot. In addition, the operator is provided with an easily configurable percentage which represents the cost of funding the progressive jackpot(s).

In another embodiment, the contribution may be divided by the total number of player positions on the table regardless of the number of active or average players. In this embodiment, the player count would be the total number of player positions. This player count may be used by conservative operators, since the funding of the progressive jackpot may not be paid out entirely over the long average if the number of players is ever less than the number of player positions.

In another exemplary embodiment, a blackjack gaming table includes a display 120 shared by all players of the table. Wager detectors 116 at each player position detect if a qualifying wager (e.g., side wager) has been made for the current round of the base game of blackjack. A dealer initiated game start button 612 may be used to signal the start of the base game play, and hence the start of the bonus side game. Players that have made a side wager are locked in as eligible players of the bonus game. Such a lock-in procedure may include the lighting of the side wager chip detector 116. In some embodiments, after activating a “Start” button, the dealer may collect all side wagers first wherein the chip detector stays lit for the duration of the bonus game. This procedure simplifies, for the dealer, which players are eligible for the bonus game. In addition, late wagers are not detected by the chip detector after game start, allowing the dealer to easily manage players attempting to place a late wager into the bonus game.

A controller 136 may electronically transmit five cards out of a randomly shuffled standard deck of 52 cards to a table in response to a game start signal received by the controller from that table. It should be noted that in this embodiment, only one table shares the same five cards transmitted for each game start signal received by each table game. This is not a restriction, but serves to synchronize the secondary bonus game with blackjack table play at each table, and further serves to stabilize the maximum payout liability for the operator. In this embodiment, the five cards are considered as a poker hand, and a paytable is displayed which pays a jackpot value for each poker hand. Typical winning poker hands may comprise straight, flush, four of a kind, straight flush and royal flush. The bonus game advantageously supports progressive jackpots for all poker outcomes and payouts, including rare outcomes such as straight flush and royal flush. In this embodiment, it is noted that all participating players at the table share the same hand of poker. If the five cards complete a winning poker hand that is associated with a progressive jackpot, all participating players win the complete value of the progressive jackpot. This embodiment creates more player excitement, as all players hit the jackpot together.

In this embodiment, the controller 136 may reset the game immediately if no winning hand is detected by the system. If a winning hand is detected, the dealer may activate a game reset button to reset the game, or the game may reset automatically upon receiving another game start signal. To make the duties of the dealer easier, and to provide a system where less mistakes can be made, other signals may be processed by a client device at a gaming table to ensure the dealer and the bonus game are synchronized. For example, a dealer hole card reader can determine if the dealer's hand has been completely dealt for the base game of blackjack. This process signals the end of the round. If so, and only then, can a game reset button be activated again. A game reset button serves to help the dealer synchronize the bonus game with the underlying manually dealt base game by ensuring that the bonus game is not inadvertently activated. A game reset button will typically be part of a HID.

In yet another embodiment, a client device may sense, such as via one or more currency detectors, that side wagers have been completely removed from the table prior to allowing the reactivation of the bonus game. In this case, players are prohibited from placing wagers until the bonus game is fully reset. If a player places a side wager before the game is reset and after the bonus game start has occurred, a currency detector can flash a warning light, and inhibit the bonus game from proceeding until the wager is removed by the player. This allows the dealer an opportunity to ask players to place a side wager at the proper interval of the base game play, and ensures that only a single bonus game activation per base game round is allowed.

Various strategies may be implemented to automate the bonus game when base game cards are needed to achieve a winning outcome. For example, in the embodiment of FIG. 17, implement information may indicate when a player's hole card has been dealt and, once received, such implement information may automatically trigger determination of a qualifying wager at step 1712 and the ultimate disposition of a bonus game, such as described with regard to the steps of FIG. 17.

As another example, a player count from game start information may be utilized to automate a bonus game. As each player receives their initial hand the dealer may engage a “Sync” button or control. Once the number of “Sync” button engagements equals the player count, the table bonusing system's controller may determine that a dealing round has ended, and may continue execution of a bonus game automatically.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A table bonusing system comprising:
a deck of cards stored on a storage device;
a controller that:
randomly generates a selected card suit;
randomly generates a plurality of card draw threshold values; and
stores a jackpot value and one or more winning outcomes;
a plurality of gaming tables comprising:
a table surface bearing a plurality of player positions where one or more wagers are received;
one or more displays; and
one or more client devices that receive wager information and transmit the wager information to the controller, receive bonus game information and display the bonus game information on the one or more displays;
wherein the wager information is generated based on the amount of the one or more wagers;
wherein the bonus game information comprises a set of placed cards and the jackpot value;
wherein when the wager information indicates a qualifying wager has been placed the controller:
increments the jackpot value;
draws a card from the deck of cards when the jackpot value crosses one of the plurality of card draw thresholds;
inserts the card into the set of placed cards when the card is of the selected card suit; and
awards the jackpot when the set of placed cards is one of the one or more winning outcomes.

2. The table bonusing system of claim 1, wherein the controller awards a special card award when the wager information the qualifying wager has been placed and the card drawn from the deck of cards does not have a suit.

3. The table bonusing system of claim 1, wherein the controller awards a placed card award when the wager information the qualifying wager has been placed and the card drawn from the deck of cards is of the selected card suit.

4. The table bonusing system of claim 1, wherein the plurality of gaming tables comprise one or more currency detectors at each player position that receive the wager information, the one or more currency detectors in communication with the client device.

5. The table bonusing system of claim 1, wherein the plurality of gaming tables comprise one or more HIDs that receive the wager information, the one or more HIDs in communication with the client device.

6. The table bonusing system of claim 1, wherein the jackpot value is incremented by a percentage defined by an predefined increment rate divided by a player count.

7. The table bonusing system of claim 6, wherein two cards are drawn from the deck of cards when the set of placed cards contains three cards.

8. A table bonusing system comprising:
a plurality of gaming tables comprising a table surface for receiving a plurality of physical playing cards for play of a base game, and a communication device for transmitting wager information;
a display at each of the plurality of gaming tables that presents a jackpot and a set of placed cards;
a storage device storing a deck of cards;
a controller that provides a bonus game by:
randomly selecting a card suit;
randomly generating a plurality of card draw thresholds;
receiving the wager information;
detecting a qualifying wager based on the wager information;
incrementing the jackpot when the qualifying wager is detected;
drawing a card from the deck of cards when the jackpot crosses one of the plurality of card draw thresholds;
inserting the card into the set of placed cards when the card is of the selected card suit; and
awarding the jackpot when the set of placed cards is a winning outcome.

9. The table bonusing system of claim 8, wherein a special card award is paid when the qualifying wager is detected and the card drawn from the deck of cards has no suit.

10. The table bonusing system of claim 8, wherein a placed card award is paid when the qualifying wager is detected and the card drawn from the deck of cards is of the selected card suit.

11. The table bonusing system of claim 8 further comprising one or more currency detectors that receive the wager information at each of the gaming tables.

12. The table bonusing system of claim 8 further comprising one or more HIDs that receive the wager information at each of the gaming tables.

13. The table bonusing system of claim 8, wherein a plurality of cards are drawn from the deck of cards when the jackpot crosses one of the plurality of card draw thresholds.

14. The table bonusing system of claim 8, wherein the jackpot is incremented by a percentage defined by an predefined increment rate divided by a player count.

15. A method for providing one or more bonuses at a plurality of gaming tables comprising:
randomly selecting a suit with one or more random number generators;
randomly selected a plurality of card draw thresholds with the one or more random number generators;
receiving wager information from a plurality of gaming tables via a communication device;
incrementing a jackpot when the wager information indicates a qualifying wager has been placed;
drawing a card from a deck of cards stored on a storage device when the jackpot crosses one of the plurality of card draw thresholds;
inserting the card into a set of placed cards when the card is of the selected suit;
presenting the set of placed cards and the jackpot at the plurality of gaming tables via a display;
determining if the set of placed cards is a winning outcome; and
awarding the jackpot if the set of placed cards is a winning outcome.

16. The method of claim 15 further comprising paying a special card award when the qualifying wager has been placed and the card drawn from the deck of cards has no suit.

17. The method of claim 15 further comprising paying a placed card award when the qualifying wager has been placed and the card drawn from the deck of cards is of the selected suit.

18. The method of claim 15, wherein the wager information is received via one or more currency detectors at the plurality of gaming tables.

19. The method of claim 15, wherein the wager information is received via one or more HIDs at the plurality of gaming tables.

20. The method of claim 15, wherein the jackpot is incremented by a percentage defined by an predefined increment rate divided by a player count.
